(19) United States
(12) Patent Application Publication
(10) Pub. No.: US 2008/0052913 A1
(43) Pub. Date: Mar. 6, 2008

(54) Folding knife with blade replacement mechanism

(75) Inventor: Yang-Fu Cheng, Taipei (TW)

Correspondence Address: BACON & THOMAS, PLLC, 625 SLATERS LANE, FOURTH FLOOR, ALEXANDRIA, VA, 22314, US

(73) Assignee: KANTAS PRODUCTS CO., LTD., Taipei (TW)

(21) Appl. No.: 11/709,219

(22) Filed: Feb. 22, 2007

(30) Foreign Application Priority Data
Aug. 31, 2006 (TW) 095215419

(51) Int. Cl. B26B 1/02

(52) U.S. Cl. 30/157

(57) ABSTRACT

The present invention is to provide a folding knife comprising a handle, a blade having a fastening hole and a tang having a front cavity and a rear end distal the cavity pivotably secured to a front end of the handle. The tang comprises an integral flexible tongue with one end formed with the tang and the other end disposed corresponding to the cavity, a projection on the inner surface of the tang facing the cavity and a push member provided on a top edge of the tang facing the tongue. For mounting the blade, a user may slide the push member rearward to push an open end of the tongue away from the cavity, insert the blade into the cavity until the fastening hole lines up with the projection, and slide the push member forward to bounce the projection back into the fastening hole for fastening the blade in the cavity.

### FIELD OF THE INVENTION

The present invention relates to folding knifes and more particularly to such a folding knife having a mechanism for enabling a user to easily replace a used blade (e.g., one becomes dull) with a new one.

### BACKGROUND OF THE INVENTION

There is a rapid, significant progress of technologies in recent several decades. Products related to these technologies include high-technology products as well as consumer goods which are closely tied to our daily life. For having better standards of living, it is desirable among people to improve many kinds of consumer goods by eliminating drawbacks associated therewith.

Knifes are a typical kind of tool frequently used in our daily life. Also, there are many types of knifes available. For example, a conventional folding knife is shown in FIG. 1. The folding knife comprises a tang 100, a blade 200, and a handle 300. The hollow, rectangular tang 100 comprises a circular through hole 151 on one side surface, and a resilient piece 152 having a rear end fixedly secured to a front end of the handle 300, a bent intermediate section having a portion inserted into the through hole 151, and a front end urged against one side surface of the tang 100. A rear portion of the blade 200 is adapted to insert into a front opening of the tang 100. The blade 200 comprises a rear, circular through hole 201. The handle 300 is a hollow, elongate member and comprises a lengthwise, central slot 301. The tang 100 is pivotably secured to the handle 300. Both the tang 100 and the blade 200 are adapted to receive in the slot 301 of the handle 300 by pivoting for storage. For mounting the blade 200, a user may insert the rear of the blade 200 into the opening of the tang 100 to push the portion of the resilient piece 152 toward and out of the through hole 151. The portion of the resilient piece 152 immediately snaps into the through hole 201 for securing the blade 200 to the tang 100 when the through holes 201 and 151 are aligned. As a result, the blade 200 is mounted. For replacing the blade 200, a user has to pull the front end of the resilient piece 152 outward until the fastening portion thereof clears the through hole 201. As an end, the blade 200 and the tang 100 are disassembled.

However, the prior art folding knife suffered from several disadvantages. For example, a plurality of component manufacturing and assembly steps are required for mass producing the folding knifes. For example, bending the intermediate section of the resilient piece 152 and mounting the resilient piece 152 on the tang 100. These assembly steps are very complicated. Further, it may consume excessive time and involve intensive labor. This really bothers manufacturers of the art. Moreover, an excessive number of components and a variety of components inevitably increase the manufacturing cost. In addition, a portion of the resilient piece 152 projecting out of the tang 100 can increase the thickness of the tang 100. This in turn has the drawback of increasing difficulties of pivoting the tang 100 into the slot 301. It is understood that both the resilient piece 152 and the tang 100 can be damaged by collision if the tang 100 is not completely received in the handle 300. And in turn, the blade 200 may detach from the tang 100. All of these bring trouble and inconvenience to a user. Thus, continuing improvements in the exploitation of a folding knife having a blade replacement mechanism are constantly being sought so as to save time and labor in the manufacturing processes of folding knife.

### SUMMARY OF THE INVENTION

After considerable research and experimentation, a folding knife having a blade replacement mechanism according to the present invention has been devised so as to overcome the above drawbacks of the prior art.

It is an object of the present invention to provide a folding knife comprising a blade having a fastening hole, a tang, and a handle. The tang comprises a front cavity. A rear end of the tang distal the cavity is pivotably secured to a front end of the handle. Thus, both the tang and the blade can pivotably either receive in a lengthwise slot of the handle when not in use or extend out of the slot for use. The tang comprises an integral flexible tongue. One end of the tongue is formed with the tang and the other end thereof is disposed corresponding to the cavity. The tongue further comprises a projection on its inner surface facing the cavity. A push member is provided on a top edge of the tang facing the tongue. For mounting the blade, a user may slide the push member rearward to push an open end of the tongue away from the cavity, insert the blade into the cavity until the fastening hole lines up with the projection, and slide the push member forward to bounce the projection back into the fastening hole for fastening the blade in the cavity. To the contrary, a user may slide the push member rearward to push the open end of the tongue away from the cavity to disengage the projection with the fastening hole prior to detaching the blade from the cavity for replacement. By configuring the tongue as an integral part of the tang, materials and manufacturing cost are greatly reduced, assembly steps are significantly decreased, and the tongue is fully protected.

The above and other objects, features and advantages of the present invention will become apparent from the following detailed description taken with the accompanying drawings.

### BRIEF DESCRIPTION OF THE DRAWINGS

FIG. 1 is a perspective view of a conventional folding knife in its fully extended position with the blade detached from the tang;

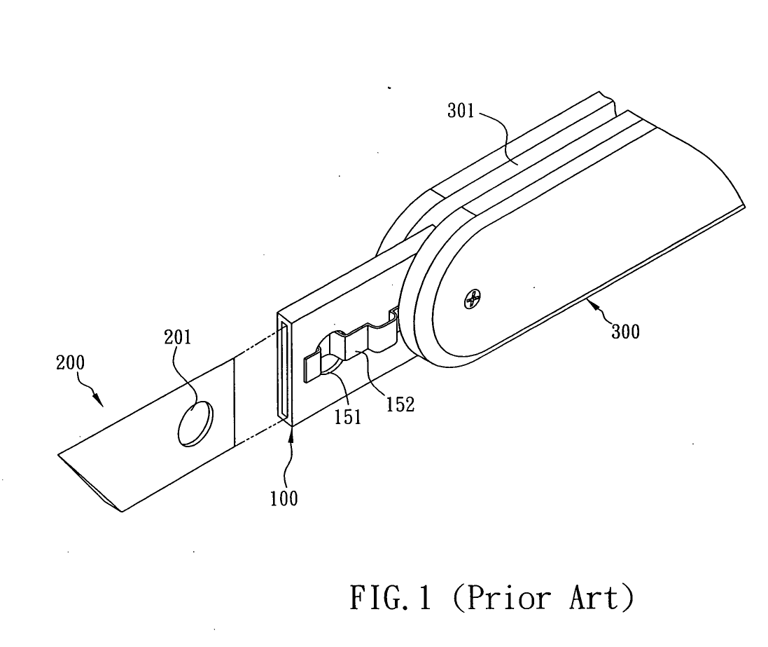

FIG. 2 is a perspective view of a first preferred embodiment of folding knife according to the invention in its fully extended position;

FIG. 3 is an exploded view of the folding knife of FIG. 2;

FIG. 4 is an exploded view of a second preferred embodiment of folding knife according to the invention;

FIG. 5 is an exploded view of a third preferred embodiment of folding knife according to the invention; and

FIG. 6 is an exploded view of a fourth preferred embodiment of folding knife according to the invention.

### DETAILED DESCRIPTION OF THE PREFERRED EMBODIMENTS

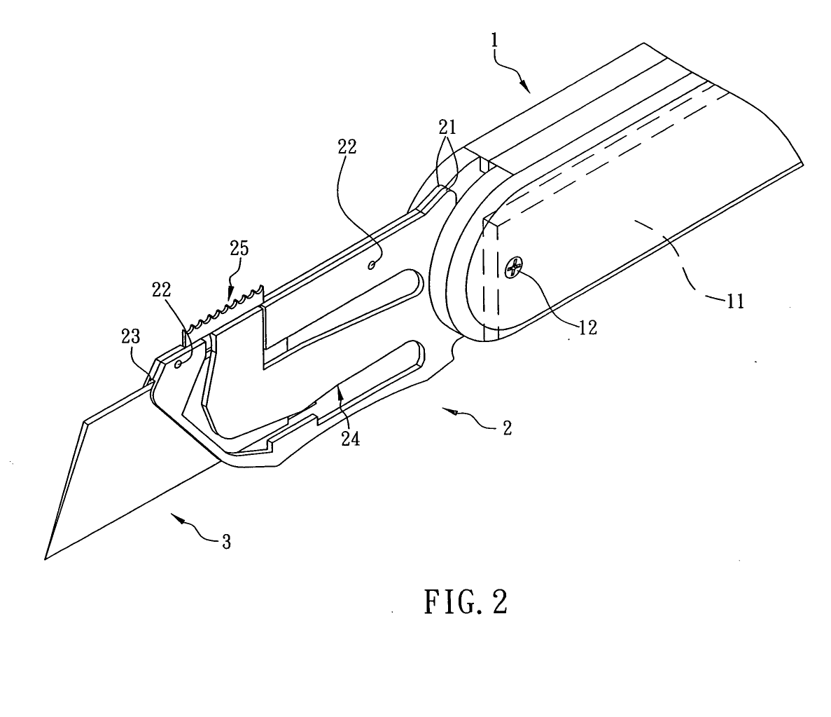

Referring to FIG. 2, a folding knife in accordance with a first preferred embodiment of the invention comprises a blade 3, a tang 2, and a handle 1. Each component is discussed in detailed below.

The tang 2 comprises two elongate pieces 21 of substantially rectangular in shape, a plurality of fasteners 22 for fastening the pieces 21 together, and a front parallelogram cavity 23 provided in one piece 21 for anchoring a rear end of the blade 3 as detailed later. Rear portions of the pieces 21 are pivotably secured to a front end of the handle 1 by means of a pin 12. Thus, both the tang 2 and the blade 3 can pivotably either receive in a lengthwise, central slot 11 of the handle 1 when not in use or extend out of the slot 11 for use.

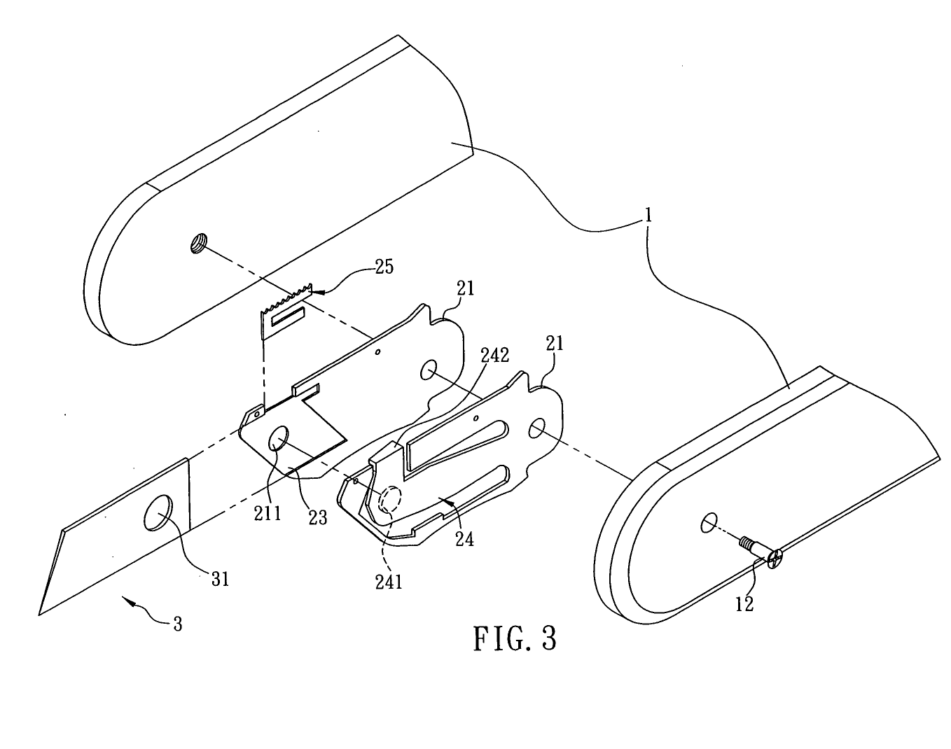

Referring to FIG. 3 in conjunction with FIG. 2, the cavity 23 is defined between and by the pieces 21 when the pieces 21 are fastened together. An L-shaped flexible tongue 24 is extended from a rear end of the other piece 21. The tongue 24 has its front portion corresponding to the cavity 23. A substantially U-shaped push member 25 is provided on a recessed top edge at a front portion of one piece 21. The tongue 24 comprises a circular projection 241 on its inner surface. For mounting the blade 3, a user may first slide the push member 25 rearward to push the open end of the tongue 24 away from the cavity 23. Then insert the blade 3 into the cavity 23 until a rear, circular through hole 31 of the blade 3 lines up with the projection 241. Next, slide the push member 25 forward. The projection 241 automatically bounces back into the through hole 31 for fastening the blade 3 in the cavity 23 due to the flexibility of the tongue 24. As a result, the blade 3 and the tang 2 are secured together. To the contrary, for detaching the blade 3 from the tang 2, a user may first slide the push member 25 rearward to push the open end of the tongue 24 away from the cavity 23. Also, the projection 241 clears the through hole 31. As such, the blade 3 is not fastened in the cavity 23. As a result, the user may remove the blade 3 out of the tang 2 for replacement. By configuring the tongue 24 as an integral part of the other piece 21 of the tang 2, materials and manufacturing cost are greatly reduced, assembly steps are significantly decreased, and the tongue 24 is fully protected.

Referring to FIGS. 2 and 3 again, in the first preferred embodiment of the invention the rear end of the tongue 24 is integrally formed with the other piece 21 proximate the front end of the handle 1 and the front end thereof is extended away from the front end of the handle 1. The tongue 24 further comprises a trapezoidal latch 242 at its open end. The latch 242 has a short front side and a long rear side (i.e., tapered from the handle 1 toward the blade 3). The U-shaped push member 25 is slidably provided on a recessed top edge at a front portion of one piece 21. The latch 242 is partially disposed in the opening of the push member 25. That is, a corner of the front side of the latch 242 proximate the rear end of the blade 3 engages with the opening of the push member 25. Thus, for detaching the blade 3 from the tang 2 a user slides the push member 25 rearward to push the open end of the tongue 24 away from the cavity 23 by sliding the push member 25 along the inclined side of the latch 242 and the projection 241 thus clears the through hole 31. As such, the blade 3 is not fastened in the cavity 23. Therefore, the user may remove the blade 3 out of the tang 2 for replacement. To the contrary, after disposing the blade 3 in the cavity 23 a user may slide the push member 25 forward. The projection 241 automatically bounces back into the through hole 31 for fastening the blade 3 in the cavity 23 due to the flexibility of the tongue 24. As a result, the blade 3 and the tang 2 are secured together.

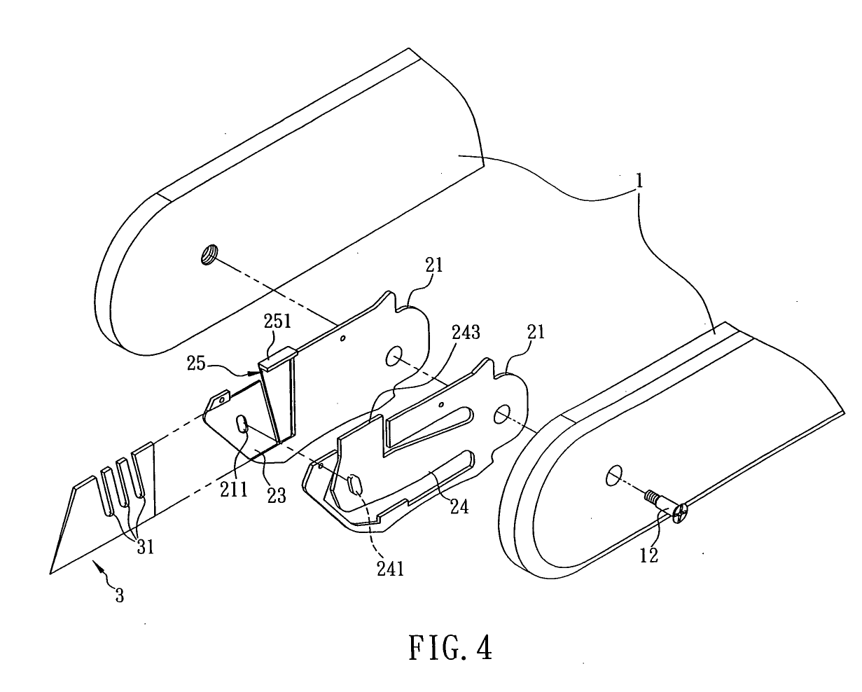

Referring to FIG. 4 in conjunction with FIG. 2, a second preferred embodiment of the invention is illustrated. The rear end of the tongue 24 is integrally formed with the other piece 21 proximate the front end of the handle 1 and the front end thereof is extended away from the front end of the handle 1. The tongue 24 comprises a rectangular protrusion 243 at its open end. One end of the flexible push member 25 is integrally formed with one piece 21 and the other end thereof is bent to form as a rectangular latch 251 facing the protrusion 243. Also, the push member 25 is adapted to slightly flex toward the protrusion 243. Further, the latch 251 bears on a top of the protrusion 243. In one operation, a user may push the open end of the push member 25 toward the open end of the tongue 24. Thus, the latch 251 presses the protrusion 243 to move the open end of the tongue 24 out of the cavity 23 until the projection 241 clears one of a plurality of recesses 31 of the blade 3. As such, the blade 3 is not fastened in the cavity 23. Therefore, the user may remove the blade 3 out of the tang 2 for replacement. To the contrary, after disposing the blade 3 in the cavity 23, the projection 241 automatically bounces back into the through hole recess 31 without manipulating the latch 251 for fastening the blade 3 in the cavity 23 due to the flexibility of the tongue 24. Also, the open end of the push member 25 returns to its original position. As a result, the blade 3 and the tang 2 are secured together.

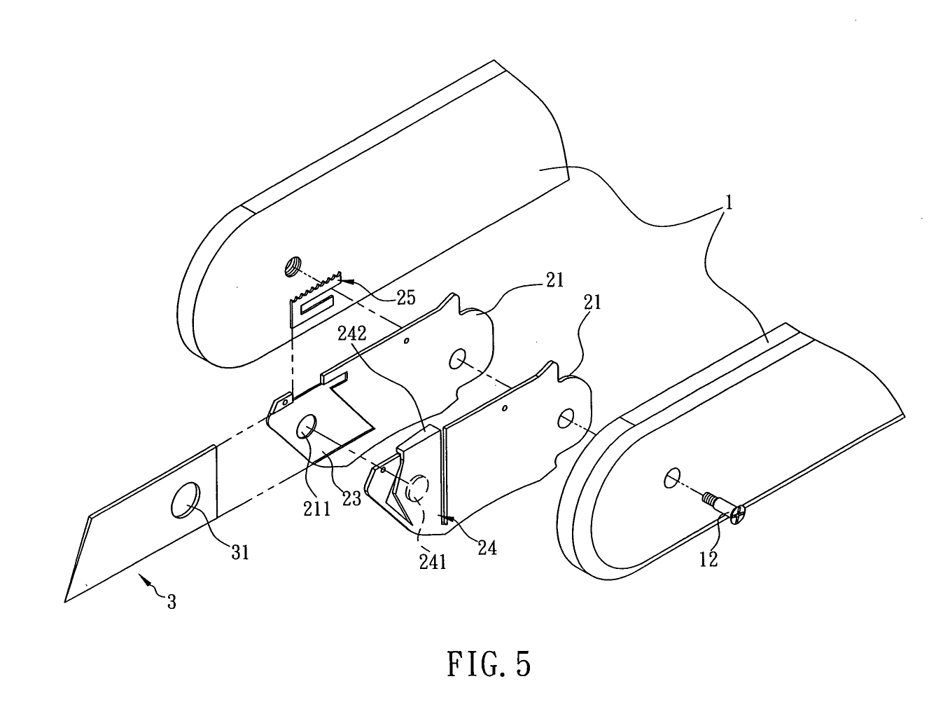

Referring to FIG. 5 in conjunction with FIG. 2, a third preferred embodiment of the invention is illustrated. One end of the flexible tongue 24 is integrally formed with the other piece 21 distal the front end of the handle 1 and the other open end thereof is bent to form a trapezoidal latch 242. The latch 242 has a short front side and a long rear side (i.e., tapered from the handle 1 toward the blade 3). The U-shaped push member 25 is slidably provided on a recessed top edge at a front portion of one piece 21. The latch 242 is partially disposed in the opening of the push member 25. That is, a corner of the front side of the latch 242 proximate the rear end of the blade 3 engages with the opening of the push member 25. Thus, for detaching the blade 3 from the tang 2 a user slides the push member 25 rearward to push the open end of the tongue 24 away from the cavity 23 by sliding the push member 25 along the inclined side of the latch 242 and the projection 241 thus clears the through hole 31. As such, the blade 3 is not fastened in the cavity 23. Therefore, the user may remove the blade 3 out of the tang 2 for replacement.

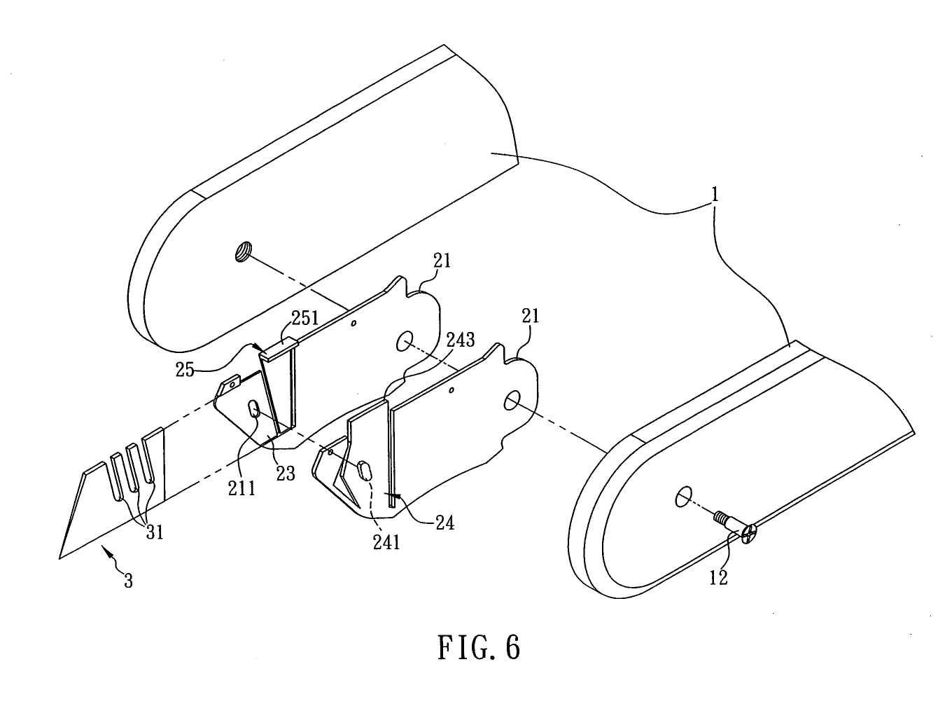

Referring to FIG. 6 in conjunction with FIG. 2, a fourth preferred embodiment of the invention is illustrated. One end of the flexible tongue 24 is integrally formed with the other piece 21 distal the front end of the handle 1 and the other open end thereof is extended to form a rectangular protrusion 243. One end of the flexible push member 25 is integrally formed with one piece 21 and the other end thereof is bent to form as a rectangular latch 251 facing the protrusion 243. Also, the push member 25 is adapted to slightly flex toward the protrusion 243. Further, the latch 251 bears on a top of the protrusion 243. In one operation, a user may push the open end of the push member 25 toward the open end of the tongue 24. Thus, the latch 251 presses the protrusion 243 to move the open end of the tongue 24 out of the cavity 23 until the projection 241 clears one of a plurality of recesses 31 of the blade 3. As such, the blade 3 is not fastened in the cavity 23. Therefore, the user may remove the blade 3 out of the tang 2 for replacement.

The blade 3 and the tang 2 in each of the preferred embodiments of the invention may be embodied as below. As shown in FIGS. 3 and 5, the through hole 31 is formed on the rear end of the blade 3 and is circular. A second through hole 211 is formed on the cavity 23. The through hole 31 is adapted to line up with the second through hole 211 when the blade 3 is mounted in the cavity 23. Further, the second through hole 211 is shaped the same as the through hole 31. That is, both of the through holes 211 and 31 have a circular shape. Furthermore, both the projection 241 and the through hole 31 are shaped the same. That is, both of the projection 241 and the through hole 31 have a circular shape. After disposing the rear end of the blade 3 in the cavity 23, the projection 241 automatically bounces back through the through hole 31 into the second through hole 211 for fastening the blade 3 in the cavity 23 by lockingly engaging the projection 241 in the second through hole 211 due to the flexibility of the tongue 24.

The blade 3 and the tang 2 in each of the preferred embodiments of the invention may be alternatively embodied as below. As shown in FIGS. 4 and 6, a plurality of elongate, slanted, parallel recesses 31 are formed a top edge of on the blade 3. The recesses 31 have an open top end and an arcuate, closed bottom end. A slanted, elliptic through hole 211 is formed on the cavity 23 and is disposed corresponding to the slanted, elliptic projection 241. After disposing the rear end of the blade 3 in the cavity 23, the projection 241 automatically bounces back through one of the recesses 31 into the through hole 211 for fastening the blade 3 in the cavity 23 by lockingly engaging the projection 241 in the through hole 211 due to the flexibility of the tongue 24.

While the invention herein disclosed has been described by means of specific embodiments, numerous modifications and variations could be made thereto by those skilled in the art without departing from the scope and spirit of the invention set forth in the claims.

What is claimed is:

1. A folding knife comprising:
a blade including at least one fastening hole; and
a tang including a front cavity, a flexible tongue integrally formed with one side surface of the tang wherein one end of the tongue is formed with one end of the tang and the other end thereof is disposed corresponding to the cavity, a projection formed on an inner surface of the tongue and disposed corresponding to the cavity wherein the projection securely inserts into the fastening hole when the blade is inserted into the cavity, and a push member mounted on a top of the tang facing the tongue,
wherein the push member is adapted to slide rearward to push the tongue away from the cavity and disengage the projection with the fastening hole for facilitating a replacement of the blade thereafter.

2. The folding knife of claim 1, wherein the tang further comprises two pieces and a plurality of fasteners for fastening the pieces together with the cavity defined by and disposed between the pieces, and wherein the cavity is formed on one piece and the push member is mounted on a top of one piece, and one end of the tongue is integrally formed with one end of the other piece and the other end thereof faces the cavity.

3. The folding knife of claim 2, wherein:
one end of the tongue is formed with one end of the other piece distal the blade and the other end thereof is extended to the other end of the other piece proximate the cavity to form a trapezoidal latch by bending, the width of the latch being increased gradually from the cavity toward a direction distal the blade; and
the push member is of substantially U and is slidably mounted on the top of one piece facing the tongue with the opening of the push member engaged with a corner of a front side of the latch proximate a rear end of the blade such that sliding the push member rearward away from the blade by sliding the push member along an inclined side of the latch will push both the other end of the tongue and the projection away from the cavity.

4. The folding knife of claim 2, wherein:
one end of the tongue is formed with one end of the other piece distal the blade and the other end thereof is extended to the other end of the other piece proximate the cavity to form a protrusion; and
one end of the push member is integrally formed with one piece and the other end thereof is bent to form as a latch facing the protrusion, the push member being adapted to slightly flex toward the protrusion and the latch bearing on the protrusion such that pushing the other end of the push member toward the tongue will cause the latch to press the protrusion and push both the other end of the tongue and the projection away from the cavity.

5. The folding knife of claim 2, wherein:
one end of the tongue is formed with one end of the other piece proximate the blade and the other end thereof is extended to the other end of the other piece to form a trapezoidal latch by bending, the width of the latch being increased gradually from the cavity toward a direction distal the blade; and
the push member is of substantially U and is slidably mounted on the top of one piece facing the tongue with the opening of the push member engaged with a corner of a front side of the latch proximate a rear end of the blade such that sliding the push member rearward away from the blade by sliding the push member along an inclined side of the latch will push both the other end of the tongue and the projection away from the cavity.

6. The folding knife of claim 2, wherein:
one end of the tongue is formed with one end of the other piece proximate the cavity and the other end thereof is extended to the other end of the other piece proximate the cavity to form a protrusion; and
one end of the push member is integrally formed with one piece and the other end thereof is bent to form as a latch facing the protrusion, the push member being adapted to slightly flex toward the protrusion and the latch bearing on the protrusion such that pushing the other end of the push member toward the tongue will cause the latch to press the protrusion and push both the other end of the tongue and the projection away from the cavity.

7. The folding knife of claim 3, wherein:
the fastening hole is formed on the rear end of the blade and is circular;
one piece further comprises a fastening aperture formed on the cavity and disposed corresponding to the projection; and
in response to disposing the rear end of the blade in the cavity, the projection bounces back through the fastening hole into the fastening aperture for fastening the blade in the cavity by lockingly engaging the projection in the fastening aperture.

8. The folding knife of claim 4, wherein:
the fastening hole is formed on the rear end of the blade and is circular;
one piece further comprises a fastening aperture formed on the cavity and disposed corresponding to the projection; and
in response to disposing the rear end of the blade in the cavity, the projection bounces back through the fastening hole into the fastening aperture for fastening the blade in the cavity by lockingly engaging the projection in the fastening aperture.

9. The folding knife of claim 5, wherein:
the fastening hole is formed on the rear end of the blade and is circular;
one piece further comprises a fastening aperture formed on the cavity and disposed corresponding to the projection; and
in response to disposing the rear end of the blade in the cavity, the projection bounces back through the fastening hole into the fastening aperture for fastening the blade in the cavity by lockingly engaging the projection in the fastening aperture.

10. The folding knife of claim 6, wherein:
the fastening hole is formed on the rear end of the blade and is circular;
one piece further comprises a fastening aperture formed on the cavity and disposed corresponding to the projection; and
in response to disposing the rear end of the blade in the cavity, the projection bounces back through the fastening hole into the fastening aperture for fastening the blade in the cavity by lockingly engaging the projection in the fastening aperture.

11. The folding knife of claim 7, further comprising a handle having a front end pivotably secured to one end of the tang, wherein the handle comprises a lengthwise slot for receiving the tang by pivoting the tang toward the handle.

12. The folding knife of claim 8, further comprising a handle having a front end pivotably secured to one end of the tang, wherein the handle comprises a lengthwise slot for receiving the tang by pivoting the tang toward the handle.

13. The folding knife of claim 9, further comprising a handle having a front end pivotably secured to one end of the tang, wherein the handle comprises a lengthwise slot for receiving the tang by pivoting the tang toward the handle.

14. The folding knife of claim 10, further comprising a handle having a front end pivotably secured to one end of the tang, wherein the handle comprises a lengthwise slot for receiving the tang by pivoting the tang toward the handle.

15. The folding knife of claim 3, wherein:
the fastening hole comprising a plurality of elongate parallel recesses having an arcuate, closed bottom end are formed on a top edge at the rear end of the blade;
one piece further comprises a fastening aperture formed on the cavity and disposed corresponding to the projection; and
in response to disposing the rear end of the blade in the cavity, the projection bounces back through one of the recesses into the fastening aperture for fastening the blade in the cavity by lockingly engaging the projection in the fastening aperture.

16. The folding knife of claim 4, wherein:
the fastening hole comprising a plurality of elongate parallel recesses having an arcuate, closed bottom end are formed on a top edge at the rear end of the blade;
one piece further comprises a fastening aperture formed on the cavity and disposed corresponding to the projection; and
in response to disposing the rear end of the blade in the cavity, the projection bounces back through one of the recesses into the fastening aperture for fastening the blade in the cavity by lockingly engaging the projection in the fastening aperture.

17. The folding knife of claim 5, wherein:
the fastening hole comprising a plurality of elongate parallel recesses having an arcuate, closed bottom end are formed on a top edge at the rear end of the blade;
one piece further comprises a fastening aperture formed on the cavity and disposed corresponding to the projection; and
in response to disposing the rear end of the blade in the cavity, the projection bounces back through one of the recesses into the fastening aperture for fastening the blade in the cavity by lockingly engaging the projection in the fastening aperture.

18. The folding knife of claim 6, wherein:
the fastening hole comprising a plurality of elongate parallel recesses having an arcuate, closed bottom end are formed on a top edge at the rear end of the blade;
one piece further comprises a fastening aperture formed on the cavity and disposed corresponding to the projection; and
in response to disposing the rear end of the blade in the cavity, the projection bounces back through one of the recesses into the fastening aperture for fastening the blade in the cavity by lockingly engaging the projection in the fastening aperture.

19. The folding knife of claim 15, further comprising a handle having a front end pivotably secured to one end of the tang, wherein the handle comprises a lengthwise slot for receiving the tang by pivoting the tang toward the handle.

20. The folding knife of claim 16, further comprising a handle having a front end pivotably secured to one end of the tang, wherein the handle comprises a lengthwise slot for receiving the tang by pivoting the tang toward the handle.

21. The folding knife of claim 17, further comprising a handle having a front end pivotably secured to one end of the tang, wherein the handle comprises a lengthwise slot for receiving the tang by pivoting the tang toward the handle.

22. The folding knife of claim 18, further comprising a handle having a front end pivotably secured to one end of the tang, wherein the handle comprises a lengthwise slot for receiving the tang by pivoting the tang toward the handle.

23. A folding knife comprising:
a blade; and
a tang including a front cavity, a flexible tongue integrally formed with one side surface of the tang wherein one end of the tongue is formed with one end of the tang and the other end thereof is disposed corresponding to the cavity, a projection formed on an inner surface of the tongue and disposed corresponding to the cavity wherein the projection securely inserts into the fastening hole when the blade is inserted into the cavity, and a push member mounted on a top of the tang facing the tongue,
wherein the push member is adapted to slide rearward to push the tongue away from the cavity and disengage the projection with the fastening hole for facilitating a replacement of the blade thereafter.

24. The folding knife of claim 23, wherein the tang further comprises two pieces and a plurality of fasteners for fastening the pieces together with the cavity defined by and disposed between the pieces, and wherein the cavity is formed on one piece and the push member is mounted on a top of one piece, and one end of the tongue is integrally formed with one end of the other piece and the other end thereof faces the cavity.

25. The folding knife of claim 24, wherein:
one end of the tongue is formed with one end of the other piece distal the blade and the other end thereof is extended to the other end of the other piece proximate the cavity to form a trapezoidal latch by bending, the width of the latch being increased gradually toward one end of the piece; and
the push member is of substantially U and is slidably mounted on the top of one piece facing the tongue with the opening of the push member engaged with a corner of a front side of the latch proximate the cavity such that sliding the push member rearward away from the blade by sliding the push member along an inclined side of the latch will push both the other end of the tongue and the projection away from the cavity.

26. The folding knife of claim 24, wherein:
one end of the tongue is formed with one end of the other piece proximate the cavity and the other end thereof is extended to the other end of the other piece proximate the cavity to form a protrusion; and
one end of the push member is integrally formed with one piece and the other end thereof is bent to form as a latch facing the protrusion, the push member being adapted to slightly flex toward the protrusion and the latch bearing on the protrusion such that pushing the other end of the push member toward the tongue will cause the latch to press the protrusion and push both the other end of the tongue and the projection away from the cavity.

27. The folding knife of claim 24, wherein:
one end of the tongue is formed with one end of the other piece distal the cavity and the other end thereof is extended to the other end of the other piece to form a trapezoidal latch by bending, the width of the latch being increased gradually toward one end of the piece; and
the push member is of substantially U and is slidably mounted on the top of one piece facing the tongue with the opening of the push member engaged with a corner of a front side of the latch proximate the cavity such that sliding the push member rearward away from the blade by sliding the push member along an inclined side of the latch will push both the other end of the tongue and the projection away from the cavity.

28. The folding knife of claim 24, wherein:
one end of the tongue is formed with one end of the other piece proximate the cavity and the other end thereof is extended to the other end of the other piece proximate the cavity to form a protrusion; and
one end of the push member is integrally formed with one piece and the other end thereof is bent to form as a latch facing the protrusion, the push member being adapted to slightly flex toward the protrusion and the latch bearing on the protrusion such that pushing the other end of the push member toward the tongue will cause the latch to press the protrusion and push both the other end of the tongue and the projection away from the cavity.

29. The folding knife of claim 25, further comprising a handle having a front end pivotably secured to one end of the tang, wherein the handle comprises a lengthwise slot for receiving the tang by pivoting the tang toward the handle.

30. The folding knife of claim 26, further comprising a handle having a front end pivotably secured to one end of the tang, wherein the handle comprises a lengthwise slot for receiving the tang by pivoting the tang toward the handle.

31. The folding knife of claim 27, further comprising a handle having a front end pivotably secured to one end of the tang, wherein the handle comprises a lengthwise slot for receiving the tang by pivoting the tang toward the handle.

32. The folding knife of claim 28, further comprising a handle having a front end pivotably secured to one end of the tang, wherein the handle comprises a lengthwise slot for receiving the tang by pivoting the tang toward the handle.
